(19) United States
(12) Patent Application Publication
(10) Pub. No.: US 2024/0139673 A1
(43) Pub. Date: May 2, 2024

(54) METHOD AND APPARATUS FOR DRYING A PROCESS GAS

(71) Applicant: HIGHVIEW ENTERPRISES LIMITED, London (GB)

(72) Inventor: Andrew David WRIGHT, Lymm, Cheshire (GB)

(21) Appl. No.: 18/546,906

(22) PCT Filed: Feb. 14, 2022
(86) PCT No.: PCT/EP2022/053538

§ 371 Date: Aug. 17, 2023

(30) Foreign Application Priority Data
Feb. 19, 2021 (GB) 2102392.4

(51) Int. Cl. B01D 53/26; B01D 53/04

(52) U.S. Cl. CPC B01D 53/261; B01D 53/0438; B01D 53/0454; B01D 2253/108; B01D 2257/504; B01D 2257/80; B01D 2259/4009; B01D 2259/403

(57) ABSTRACT

The present disclosure relates to an apparatus (10) for drying a process gas. The apparatus (10) includes a principal adsorption unit (11) having an inlet (14) for receiving a process gas from a compressor, and an outlet (16) for discharging the process gas. A first supplemental adsorption unit (12) has an adsorbent for adsorbing water. A second supplemental adsorption unit (13) also has an adsorbent for adsorbing water. The apparatus (10) is configured to fluidly connect the outlet of the principal adsorption unit (16) to at least one of the first and second supplemental adsorption units (12, 13). The at least one of the first and second supplemental adsorption units (12, 13) is operable to adsorb water to dry the process gas discharged from the principal adsorption unit. The present disclosure also relates to a method of drying a process gas; a control unit; and a non-transitory computer-readable medium.

### TECHNICAL FIELD

The present disclosure relates to a method and apparatus for drying a process gas. More particularly, but not exclusively, the present invention relates to a method and apparatus for adsorbing water to reduce the dew point of the process gas. Alternatively, or in addition, the method and apparatus may adsorb contaminants, such as carbon dioxide (CO2), from the process gas.

### BACKGROUND

It is desirable in certain industrial processes to lower the dew point of a process gas, such as air. This is of particular importance in low temperature processes, for example involving cryogenic fluid. Cryogenic fluids may, for example, be used in the generation of electrical energy from waste heat. The higher the dew point, the more frequently the plant will need to be de-rimed (defrosted) and this may add cost to the plant operation. Designing the adsorption unit to produce a much lower dew-point product stream (e.g. less than −70° C. or less than −100° C.) may be advantageous. By lowering the dew point, the need to de-rime (defrost) the plant may be reduced. This may allow enable extended operation of the plant between plant defrosts. There may be other opportunities to reduce the operating and/or capital cost of the adsorption unit.

At least in certain embodiments, the present invention seeks to address or overcome limitations associated with prior art systems.

### SUMMARY OF THE INVENTION

Aspects of the present invention relate to apparatus, a method and a non-transitory computer-readable medium as claimed in the appended claims.

According to a further aspect of the present invention there is provided apparatus for drying a process gas, the apparatus comprising:
a principal adsorption unit having an inlet for receiving a process gas from a compressor, and an outlet for discharging the process gas;
a first supplemental adsorption unit comprising an adsorbent for adsorbing water; and
a second supplemental adsorption unit comprising an adsorbent for adsorbing water;
wherein the apparatus is configured to fluidly connect the outlet of the principal adsorption unit to at least one of the first and second supplemental adsorption units, the at least one of the first and second supplemental adsorption units being operable to adsorb water to dry the process gas discharged from the principal adsorption unit.

The process gas supplied from the compressor has a relatively high water content and may be referred to as a wet process gas. In use, the principal adsorption unit performs drying of the process gas supplied from the compressor. In use, the at least one of the first and second supplemental adsorption units adsorb water from the process gas discharged from the principal adsorption unit. The at least one of the first and second supplemental adsorption units thereby perform supplementary drying of the process gas. The process gas received from the compressor may be referred to as a wet process gas. The process gas discharged from the at least one of the first and second supplemental adsorption units may be referred to as a dry process gas. The additional drying is performed to lower the dew point of the process gas. At least in certain embodiments, the apparatus may dry to the process gas to lower the dew point to less than or equal to: −70° C. (−94° F.), −80° C. (−112° F.), −90° C. (−130° F.) or −100° C. (−148° F.).

The first and second supplemental adsorption units may both be operative to dry the process gas discharged from the principal adsorption unit. For example, the first and second supplemental adsorption units could both be connected in parallel or in series.

Alternatively, the apparatus may be configured to fluidly connect a selected one of the first and second supplemental adsorption units to the outlet of the principal adsorption unit. The selected one of the first and second supplemental adsorption units may dry the process gas and discharge a dry process gas.

At least in certain embodiments, one of the first and second supplemental adsorption units may be configured to dry the process gas while the other one of the first and second supplemental adsorption units is configured to be regenerated. The apparatus can be reconfigured to alternate the respective first and second supplemental adsorption units between drying and regeneration.

The one or more adsorbent in the first supplemental adsorption unit may comprise a molecular sieve adsorbent having a porous structure. The molecular sieve adsorbent may comprise a crystalline aluminosilicate or a zeolite. A plurality of adsorbents may be disposed in the first supplemental adsorption unit. The adsorbents may form a plurality of layers.

The one or more adsorbent in the second supplemental adsorption unit may comprise a molecular sieve adsorbent having a porous structure. The molecular sieve adsorbent may comprise a crystalline aluminosilicate or a zeolite. Each adsorbent may be disposed in a layer in the second supplemental adsorption unit. A plurality of adsorbents may be disposed in the second supplemental adsorption unit. The adsorbents may form a plurality of layers.

The apparatus may be configured to supply a regeneration gas to the other one of the first and second supplemental adsorption units to regenerate the adsorbent disposed therein.

The apparatus may be configured to establish a flow of the process gas through each of the first and second supplemental adsorption units in a first direction. The regeneration gas may be supplied through the first and second supplemental adsorption units in the first direction (i.e. in the same direction as the process gas). Alternatively, the regeneration gas may be supplied through the first and second supplemental adsorption units in a second direction. The second direction may be opposite to the first direction.

The regeneration gas may comprise at least a portion of the dry process gas discharged from the selected one of the first and second supplemental adsorption units.

The apparatus may comprise a transfer conduit for supplying the dry process gas to the selected one of the first and second supplemental adsorption units. A control valve may be provided for controlling the supply of the dry process gas between the first and second supplemental adsorption units. Alternatively, or in addition, a flow restrictor may be provided in the transfer conduit. The flow restrictor could be a variable flow restrictor.

The flow rate of the regeneration gas may be constant or may be varied. The flow rate of the regeneration gas may be increased or decreased with respect to time. For example, substantially all of the dry process gas may be suppled for a (predetermined) period of time. Subsequently, the flow rate of the dry process gas may be reduced.

The apparatus may comprise a heater for heating the regeneration gas. The heater may be configured to heat the dry process gas supplied from the selected one of the first and second supplemental adsorption units prior to introduction into the other one of the first and second supplemental adsorption units.

During a regeneration process, the heater may be activated for a first time period; and may then be deactivated for a second time period. The regeneration gas may be supplied throughout the regeneration process. The second time period may be longer than the first time period.

The apparatus may be configured to introduce the regeneration gas into the principal adsorption unit after being supplied to the other one of the first and second supplemental adsorption units to regenerate the adsorbent disposed therein. The apparatus may comprise a return conduit for introducing the regeneration gas into the principal adsorption unit.

The apparatus may comprise a cooler for cooling the regeneration gas prior to introduction into the principal adsorption unit. The cooler may comprise a suitable cooling device.

The apparatus may comprise a compressor for compressing the regeneration gas prior to introduction into the principal adsorption unit.

The apparatus may be configured to change the selection one of the first and second supplemental adsorption units such that the other one of the first and second supplemental adsorption units is operative to dry the process gas and discharging a dry process gas.

The apparatus may be configured also to change which one of the first and second supplemental adsorption units is regenerated. The regeneration gas may be supplied to the other one of the first and second supplemental adsorption units to regenerate the adsorbent disposed therein.

According to a further aspect of the present invention there is provided a method of drying a process gas, the method comprising:
discharging the process gas from a principal adsorption unit;
selectively supplying the process gas from the principal adsorption unit to at least one of a first supplemental adsorption unit and a second supplemental adsorption unit, the at least one of the first and second supplemental adsorption units adsorbing water to dry the process gas.

The method may comprise fluidly connecting a selected one of the first and second supplemental adsorption units to the principal adsorption unit, the selected one of the first and second supplemental adsorption units drying the process gas and discharging a dry process gas.

The method may comprise supplying a regeneration gas to the other one of the first and second supplemental adsorption units to regenerate an adsorbent disposed therein. The regeneration gas may comprise at least a portion of the dry process gas discharged from the selected one of the first and second supplemental adsorption units.

The method may comprise heating the regeneration gas. The method may comprise, during a regeneration process, supplying the heated regeneration gas for a first time period and supplying the unheated regeneration gas for a second time period. The second time period may be longer than the first time period.

The method may comprise introducing the regeneration gas into the principal adsorption unit after being supplied to the other one of the first and second supplemental adsorption units to regenerate the adsorbent disposed therein.

The method may comprise cooling the regeneration gas prior to introduction into the principal adsorption unit.

The method may comprise compressing the regeneration gas prior to introduction into the principal adsorption unit.

The method may comprise changing the selected one of the first and second supplemental adsorption units such that the other one of the first and second supplemental adsorption units is operative to dry the process gas and discharge a dry process gas.

The method comprises also changing which one of the first and second supplemental adsorption units is regenerated. The regeneration gas may be supplied to the other one of the first and second supplemental adsorption units to regenerate the adsorbent disposed therein.

According to a further aspect of the present invention there is provided apparatus for drying a process gas, the apparatus comprising: a first adsorption unit comprising an adsorbent for adsorbing water; and a second adsorption unit comprising an adsorbent for adsorbing water; wherein the apparatus is configured to supply a process gas to at least one of the first and second adsorption units, the at least one of the first and second adsorption units being operable to adsorb water to dry the process gas. The apparatus may be configured to supply the process gas to a selected one of the first and second adsorption units for drying. At least in certain embodiments, one of the first and second adsorption units may be configured to dry the process gas while the other one of the first and second adsorption units is configured to be regenerated. The apparatus may be configured to supply a regeneration gas to the other one of the first and second adsorption units to regenerate the adsorbent disposed therein. The regeneration gas may comprise at least a portion of the dry process gas discharged from the selected one of the first and second adsorption units. The apparatus can be reconfigured to alternate the respective first and second adsorption units between drying and regeneration.

According to a further aspect of the present invention there is provided a method of drying a process gas, the method comprising selectively supplying a process gas to at least one of a first adsorption unit and a second adsorption unit, the at least one of the first and second adsorption units adsorbing water to dry the process gas. The method may comprise supplying the process gas to a selected one of the first and second adsorption units, the selected one of the first and second adsorption units drying the process gas. The method may comprise supplying a regeneration gas to the other one of the first and second adsorption units to regenerate an adsorbent disposed therein. The regeneration gas may comprise at least a portion of the dry process gas discharged from the selected one of the first and second adsorption units. The method may comprise alternating the respective first and second adsorption units between drying and regeneration.

According to a further aspect of the present invention there is provided a non-transitory computer-readable medium having a set of instructions stored therein which, when executed, cause a processor to perform the method described herein.

According to a further aspect of the present invention there is provided a control unit for controlling operation of the apparatus described herein. The control unit may comprise one or more electronic processor and a memory system. The control unit may be configured to control operation of the control valves to control the supply of the process gas from the principal adsorption unit to the first supplemental adsorption unit and/or the second supplemental adsorption unit. The control unit may also control operation of the heater and/or the cooler.

Any control unit or controller described herein may suitably comprise a computational device having one or more electronic processors. The system may comprise a single control unit or electronic controller or alternatively different functions of the controller may be embodied in, or hosted in, different control units or controllers. As used herein the term “controller” or “control unit” will be understood to include both a single control unit or controller and a plurality of control units or controllers collectively operating to provide any stated control functionality. To configure a controller or control unit, a suitable set of instructions may be provided which, when executed, cause said control unit or computational device to implement the control techniques specified herein. The set of instructions may suitably be embedded in said one or more electronic processors. Alternatively, the set of instructions may be provided as software saved on one or more memory associated with said controller to be executed on said computational device. The control unit or controller may be implemented in software run on one or more processors. One or more other control unit or controller may be implemented in software run on one or more processors, optionally the same one or more processors as the first controller. Other suitable arrangements may also be used.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the present invention will now be described, by way of example only, with reference to the accompanying figures, in which:

FIG. 1 shows a schematic representation of an apparatus in accordance with an embodiment of the present invention in a first configuration;

FIG. 2 shows a schematic representation of an adsorption unit of the apparatus shown in FIG. 1;

FIG. 3 shows a schematic representation of the apparatus shown in FIG. 1 in a second configuration;

FIG. 4 shows a block diagram representing operation of the apparatus according to an embodiment of the present invention; and

FIG. 5 shows a schematic representation of an electronic control unit of the apparatus shown in FIG. 1.

### DETAILED DESCRIPTION

Apparatus 10 for drying a process gas according to an aspect of the present invention will now be described with reference to the accompanying figures. The process gas in the present embodiment is air. The apparatus 10 is configured to dry the process gas to remove water in order to lower a dew point of the process gas. The apparatus 10 in the present embodiment is configured to dry the process gas to achieve a dew point of at least −70° C. (minus 70° C.), and preferably to achieve a dew point of −100° C. (minus 100° C.). By reducing the dew point, the need to de-rime (defrost) plant equipment downstream of the apparatus 10 may be reduced.

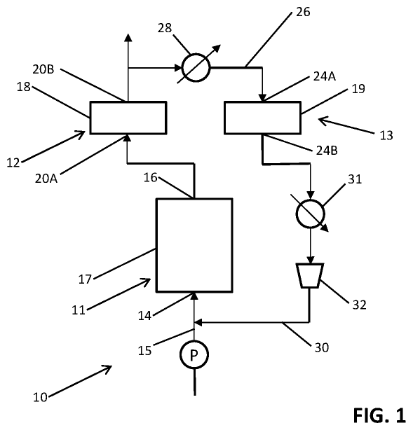

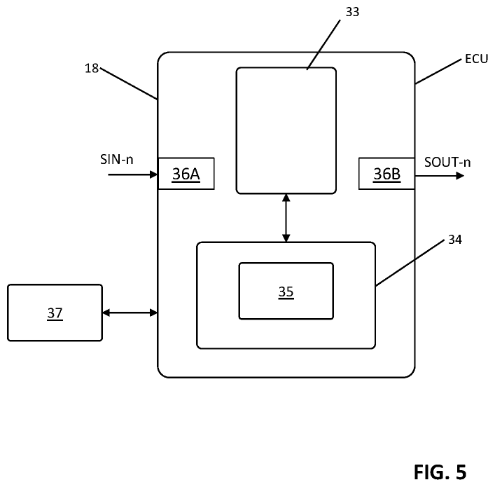

As shown in FIG. 1, the apparatus 10 comprises a principal adsorption unit 11, a first adsorption 12 and a second supplemental adsorption unit 13. The principal adsorption unit 11 comprises an inlet port 14 which is connected to a supply line 15 for receiving the process gas from a compressor (P); and an outlet port 16 for discharging the process gas. An electronic control unit (ECU) (shown in FIG. 5) is provided for controlling operation of the apparatus 10. The process gas received from the compressor has a relatively high water content and may be referred to as a wet process gas. The principal adsorption unit 11 in the present embodiment is configured partially to dry the process gas supplied from the compressor. The process gas discharged from the principal adsorption unit 11 may be referred to as a partially dry process gas. The principal adsorption unit 11 comprises one or more adsorbent for treating the process gases. The adsorbent in the principal adsorption unit 11 may comprise a molecular sieve adsorbent, such as a crystalline aluminosilicate (known as a zeolite). The molecular sieve adsorbent has a porous structure which is suitable for adsorbing water from the process gas. The molecular sieve adsorbent may also adsorb carbon dioxide (CO2) from the process gas. A suitable molecular sieve is type 13X adsorbent available from Zeochem®. Type 13X adsorbent is a sodium form of zeolite X has a larger pore opening. Calcium X (CaX) is the calcium-exchanged form of the type 13X zeolite. The molecular sieve adsorbent is arranged in one or more bed (not shown) in the principal adsorption unit 11 to adsorb water from the process gases. The principal adsorption unit 11 comprises a pressure vessel 17 configured to support operating pressures greater than atmospheric pressure. The pressure vessel 17 in the present embodiment has a diameter of approximately 3.6 metres and a length of approximately 5 metres. The process gas discharged from the principal adsorption unit 11 has a time-averaged carbon dioxide (CO2) concentration of 1 ppm and a dew point of approximately −40° C. (minus 40° C.).

The principal adsorption unit 11 is configured to dry the process gas to achieve a target dew point of −70° C. (minus 70° C.). As described herein, the first and second supplemental adsorption units 12, 13 are configured to achieve a dew point which is less than or equal to −70° C. (minus 70° C.), which may be less than or equal to −100° C. (minus 100° C.). The first supplemental adsorption unit 12 and the second supplemental adsorption unit 13 are effective also in reducing the time-averaged carbon dioxide (CO2) concentration. At least in certain embodiments, the carbon dioxide (CO2) concentration may be reduced from 1 ppm (part per million) in the process gas to 100 ppb (parts per billion). The process gas dried by the first supplemental adsorption unit 12 and/or the second supplemental adsorption unit 13 is output for use in an industrial process. The apparatus 10 has particular application in drying the process gas for use in the generation of electricity from waste heat.

The first supplemental adsorption unit 12 and the second supplemental adsorption unit 13 are configured to provide supplemental drying of the process gas. The first and second supplemental adsorption units 12, 13 may each be referred to as a polishing adsorber or a supplemental adsorber. The first and second supplemental adsorption units 12, 13 have substantially the same configuration as each other. The first and second supplemental adsorption units 12, 13 comprise respective first and second adsorption vessels 18, 19. The first and second adsorption vessels 18, 19 have substantially the same diameter as the pressure vessel 17 of the principal adsorption unit 11. In the present embodiment, the first and second adsorption vessels 18, 19 each have a diameter of approximately 3.6 metres, and a length of approximately 1 metre. The first and second adsorption vessels 18, 19 could be pressure vessels. However, in the present embodiment, the first and second adsorption vessels 18, 19 are non-pressure vessels. The first and second adsorption vessels 18, 19 are adapted to withstand temperature cycling. The first adsorption vessel 18 comprises a first process gas inlet 20A, a first process gas outlet 20B, a first regeneration gas inlet 21A and a first regeneration gas outlet 21B. In the present embodiment, the first process gas inlet 20A and the first regeneration gas outlet 21B are disposed in a lower portion or a lower wall of the first adsorption vessel 18; and the first process gas outlet 20B and the first regeneration gas inlet 21B are disposed in an upper portion or an upper wall of the first adsorption vessel 18. The second adsorption vessel 19 comprises a second process gas inlet 23A, a second process gas outlet 23B, a second regeneration gas inlet 24A and a second regeneration gas inlet 24B. In the present embodiment, the second process gas inlet 23A and the second regeneration gas outlet 24B are disposed in a lower portion or a lower wall of the second adsorption vessel 19; and the second process gas outlet 23B and the second regeneration gas inlet 24A are disposed in an upper portion or an upper wall of the second adsorption vessel 18.

The first and second supplemental adsorption units 12, 13 each comprise one or more adsorbent. The or each adsorbent is provided to adsorb water present in the process gas discharged from the principal adsorption unit 11. The adsorbent(s) may form one or more layer L-n in the respective first and second adsorption vessels 18, 19. In use, the process gas flows through the one or more adsorbent. The water in the process gas is adsorbed by the one or more adsorbent, thereby drying the process gas. The first and second supplemental adsorption units 12, 13 periodically undergo a regeneration process to desorb the water. During a regeneration process, a regeneration gas is supplied to regenerate the adsorbent in the first and second supplemental adsorption units 12, 13. As described herein, one of the first and second supplemental adsorption units 12, 13 is regenerated while the other one of the first and second supplemental adsorption units 12, 13 continues to dry the process gas from the principal adsorption unit 11. The regeneration gas could comprise a dry gas supplied from a dedicated source. The regeneration gas may, for example, comprise air that has been dried by a suitable drier or separate adsorber. In the present embodiment, the regeneration gas comprises the dry process gas from one of the first and second supplemental adsorption units 12, 13.

In the present embodiment, the first and second supplemental adsorption units 12, 13 each comprise an adsorbent comprising or consisting of activated alumina (alumina desiccant). The amount of adsorbent required may be relatively small due to the very small amounts of impurities that need to be removed from the process gas. In practice, the resulting depth of the adsorbent required can be less than that in the adsorbent beds disposed in the principal adsorption unit 11. A smaller depth of adsorbent helps enable good flow distribution. The activated alumina forms an adsorbent bed having a depth of approximately 0.5 metres. A minimum bed depth of one (1) metre may be appropriate to achieve the required flow distribution. The activated alumina is operative to adsorb water from the process gas to dry the process gas. The activated alumina is operative also to adsorb carbon dioxide (CO2) from the process gas, thereby performing a cleaning function. The pressure-drop over the first and second supplemental adsorption units 12, 13 may be about a fifth of that over that of the principal adsorption unit 11, for example approximately 40 mbar. Alternatively, or in addition, the adsorbent in the first and second supplemental adsorption units 12, 13 may comprise a molecular sieve adsorbent. The molecular sieve adsorbent may be of the type described herein with respect to the principal adsorbent unity 11. The molecular sieve adsorbent may require additional heating to regenerate the adsorbent. In a variant, the first and second supplemental adsorption units 12, 13 may each comprise an adsorbent comprising or consisting of a crystalline aluminosilicate.

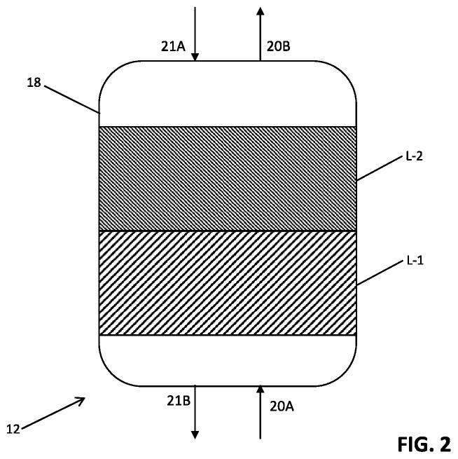

As shown in FIG. 2, the first and second supplemental adsorption units 12, 13 may each comprise a first adsorbent layer L-1 comprising or consisting of activated alumina; and a second adsorbent layer L-2 comprising or consisting of molecular sieve adsorbent. The first and second adsorbent layers L-1, L-2 may each have a depth of approximately 0.5 metres. The adsorbent in each of the first and second adsorbent layers L-1, L-2 should be sufficient to remove the required quantity of water and carbon dioxide (CO2) from the process gas. The first and second supplemental adsorption units 12, 13 may be arranged such that the process gas flows through the activated alumina and then through the molecular sieve adsorbent in the second adsorbent layer L-2. The first adsorbent layer L-1 of activated alumina is disposed proximal to the first and second process gas inlets 20A, 23A in the respective adsorption vessels 18, 19. The second adsorbent layer L-2 of molecular sieve adsorbent is disposed proximal to the first and second regeneration gas inlets 21A, 24A in the respective adsorption vessels 18, 19.

During a regeneration process, the second adsorbent layer L-2 composed of the molecular sieve adsorbent is exposed to higher temperature regeneration gases, thereby promoting regeneration. This may help to ensure regeneration throughout the adsorbent layer even near the walls of the first and second adsorption vessels 18, 19 where higher heat loss may occur. The second adsorbent layer L-2 of molecular sieve adsorbent in this arrangement is provided on top of the first adsorbent layer L-1 of activated alumina. The first adsorbent layer L-1 of activated alumina may be regenerated at the lower temperatures achieved as a result of the location distal from the regeneration gas inlet 21A, 24A. It will be understood that different adsorbents may be used in the first and second supplemental adsorption units 12, 13.

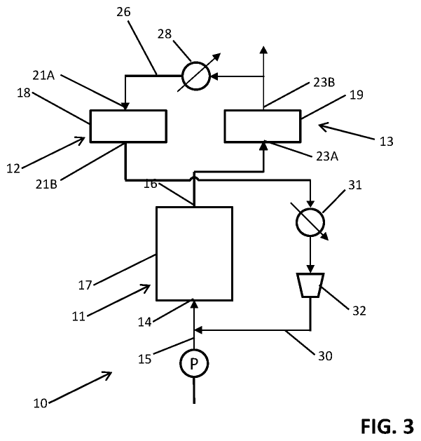

The apparatus 10 is operable selectively to configure one of the first and second supplemental adsorption units 12, 13 to process the process gas discharged from the principal adsorption unit 11; and to configure the other one of the first and second supplemental adsorption units 12, 13 for regeneration. In the arrangement shown in FIG. 1, the first supplemental adsorption unit 12 is configured to dry (or clean) the process gas discharged from the principal adsorption unit 11; and the second supplemental adsorption unit 13 is configured for regeneration. The dry process gas is discharged from the first supplemental adsorption unit 12 in this configuration. The dry process gas is used as a regeneration gas for regenerating the other one of the first and second supplemental adsorption units 12, 13. At least a portion of the dry process gas is selectively supplied from the from the first supplemental adsorption unit 12 to the second supplemental adsorption unit 13 to perform regeneration. The operation of the apparatus 10 is described herein with respect to the configuration shown in FIG. 1. The apparatus 10 can be re-configured to reverse the operation of the first and second supplemental adsorption units 12, 13, as shown in FIG. 3.

A transfer conduit 26 is provided for supplying dry process gas from the first supplemental adsorption unit 12 to the second supplemental adsorption unit 13 for regeneration of the second supplemental adsorption unit 13. A first control valve 27 is provided to control the supply of the dry process gas in the transfer conduit 26. Whilst regeneration of activated alumina at high pressure is generally avoided as it results in rapid hydrothermal ageing of the material, the trace amount of water present in the second supplemental adsorption unit 13 is not expected to cause particular problems in this regard. A flow restrictor may optionally be provided in the transfer conduit 26 to control the flow rate. A heater 28 is provided for heating the dry process gas prior to introduction into the second supplemental adsorption unit 13. The heater 28 may, for example, comprise an electrical heater having one or more heating element. The heater 28 is configured to heat the dry process gas to a regeneration temperature suitable for regenerating the adsorbent in the second supplemental adsorption unit 13. The heater 28 has a power rating of approximately 115 kW in the present embodiment. The heater 28 is configured to heat the dry process gas to a temperature of 200° C. or higher. A regeneration temperature of 200° C. is sufficient to cause the activated alumina to release trapped water, thereby regenerating the activated alumina (and or the molecular sieve adsorbent). With the heating time and a 200° C. regeneration temperature, the energy input is significantly greater (by a factor of approximately 20) than that theoretically needed to remove the CO2 and water from the bed. In a variant, a heater may be provided inside of the first and second adsorber units 12, 13 directly to heat the adsorbent.

During a regeneration process, the heater 28 is initially activated (energized) to heat the dry process gas supplied to the second supplemental adsorption unit 13. The dry process gas supplied to the second supplemental adsorption unit 13 is effective in heating the adsorbent in the second adsorbent vessel 19 to a regeneration temperature suitable for regenerating the adsorbent. The heater 28 is then de-activated (de-energized). The supply of the dry process gas continues for the remainder of the regeneration process to provide cooling of the adsorbent. The regeneration is performed by heating the gas for a short period of time, followed by a much longer cooling period when unheated regeneration dry process gas is supplied. During the cooling period the heat is pushed through the bed, removing water and trace amounts of carbon dioxide (CO2). The heater 28 may be active to perform heating for a first time period during the regeneration process, for example one (1) hour; and the cooling process may continue for a second time period. The second time period is longer than the first time period. For example, the first time period may be one (1) hour and the second time period may be five (5) hours. The total time for the regeneration process is six (6) hours in this example. This corresponds to an operating time of the first supplemental adsorption unit 12 to dry the process gas discharged from the principal adsorption unit 11.

A return conduit 30 is provided for returning the regeneration gas to the principal adsorption unit 11. The return conduit 30 is connected upstream of the inlet port 14 such that the regeneration gas is supplied to the principal adsorption unit 11. A cooler 31 is provided in the return conduit 30 for cooling the regeneration gas prior to introduction into the principal adsorption unit 11. A blower (or compressor) 32 is provided in the return conduit 30 to increase the pressure of the regeneration gas. A valve, such as a one-way valve, may be provided in the return conduit 30 to prevent the process gas supplied to the principal adsorption unit 11 being introduced into the return conduit 30. The principal adsorption unit 11 is then configured to process the regeneration gas. In the present embodiment, the principal adsorption unit 11 is operative to remove water from the product gas. On leaving the adsorber unit being regenerated, the regeneration gas is cooled by the cooler 31 before the blower 32 returns the gas stream back to the inlet of the principal adsorption unit 11. The water and carbon dioxide (CO2) removed by the second adsorber unit 13 is therefore recycled back around and ejected from the system via the principal adsorption unit 11. There are no pressure change steps employed by the first and second adsorber units 12, 13. There are no additional net losses of compressed air from the system.

Assuming a constant flow rate of gas used for the heating and cooling steps, the required amount is calculated to be 1800 Nm3/h (Normal Cubic Metres Per Hour). Assuming a 300 mbar pressure-drop over the principal adsorption unit 11 and 100 mbar over the first and second adsorbing units 12, 13 (which includes the beds on feed and regeneration plus the heater and cooler), there is a power requirement for the blower 32 of 2 kW at 70% efficiency. The total time-average power requirement for the apparatus 20 will therefore be relatively very low at only 21 kW.

It is believed that the first and second adsorbent units 12, 13 could operate with a feed gas composition containing up to a time-average 20 ppm carbon dioxide (CO2) with a −20° C. dew point (assuming no flow maldistribution issues and complete regeneration of all the adsorbent material(s)). It will be understood, therefore, that the first and second supplemental adsorption units 12, 13 described herein may be oversized to provide the desired operating characteristics. The length of the first and second supplemental adsorption units 12, 13 may be increased while reducing the size of the adsorbent beds in the principal adsorption unit 11 that they breakthrough more carbon dioxide (CO2). However, the carbon dioxide (CO2) regenerated from the first and second adsorbent units 12, 13 is sent back to the principal adsorption unit 11 and recaptured in the adsorption beds.

The use of the blower 32 with the second adsorbing unit 13 enables the regeneration of the adsorbent to be completed when the process performed by the principal adsorption unit 11 is offline. Whilst the heating time is only 1 hour, the cooling step over 5 hours must be performed to push the heat through the vessel and out the other end. If the main process is shut down during this time, it is still possible with the blower to circulate flow around the system and maintain the 1800 Nm3/h of flow rate required for regeneration. The regenerated bed is then held offline until the bed on feed had seen 6 hours of feed gas and can then be switched over. There could be a need for a small amount of external gas to be supplied to maintain the pressure in the system whilst this offline regeneration takes place. As the cooling step is being performed, the reduction in bed temperature will cause air to be adsorbed on the adsorbent and reduce the pressure in the system. This will be a very minor flow rate and may not be necessary in practice.

The first and second supplemental adsorption units 12, 13 are inter-changeable. The apparatus 10 is re-configured to change (or swap) the operation of the first and second supplemental adsorption units 12, 13. In particular, the apparatus 10 is re-configured such that the second supplemental adsorption unit 13 performs drying (and/or cleaning) of the process gas discharged from the principal adsorption unit 11; and the first supplemental adsorption unit 12 is regenerated. A schematic representation of the apparatus 10 in this configuration is shown in FIG. 3. The dry process gas is discharged from the second supplemental adsorption unit 13 in this configuration. At least a portion of the dry process gas may be selectively supplied from the second supplemental adsorption unit 13 to the first supplemental adsorption unit 12 in order to perform regeneration. The apparatus 10 can be re-configured automatically, or semi-automatically. For example, one or more control valves may be provided to control the fluid connection between the principal adsorption unit 11 and each of the first and second supplemental adsorption units 12, 13. The control valves may each comprise an actuator, such as a solenoid or an electromechanical actuator, for controlling opening and closing. The supply of the dry process gas through the transfer conduit 26 may be reversed to perform regeneration of the first supplemental adsorption unit 12. The heater 28 may be used to heat the dry process gas discharged from the second supplemental adsorption unit 13 in this configuration.

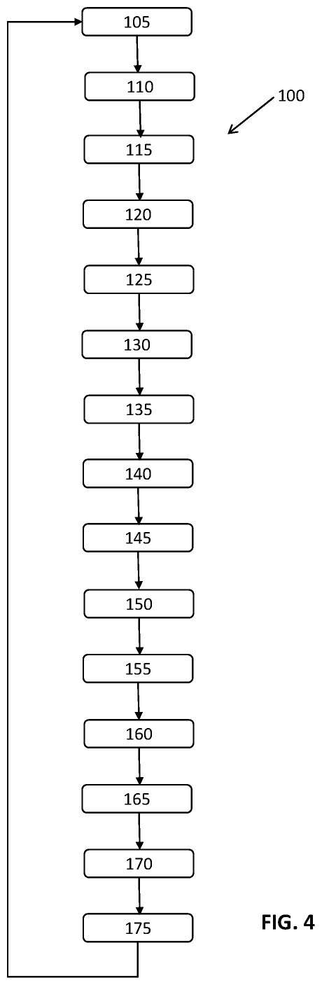

The operation of the apparatus 10 will now be described with reference to a first block diagram 100 shown in FIG. 4. The process gas is supplied to the principal adsorption unit 11 by a compressor (BLOCK 105). The process gas in the present embodiment comprises air. The principal adsorption unit 11 performs drying of the process gas (BLOCK 110). The process gas is discharged from the principal adsorption unit 11 to the first supplemental adsorption unit 12 (BLOCK 115). The first supplemental adsorption unit 12 performs supplementary drying of the process gas (BLOCK 120). The dry process gas is discharged from the first supplemental adsorption unit 12 for use downstream (BLOCK 125). A portion of the dry process gas is transferred to the second supplemental adsorption unit 13 (BLOCK 130). The heater 28 is activating to heat the dry process gas during a heating phase (BLOCK 135). The heater 28 heats the dry process gas to a predetermined temperature, for example 200° C. (BLOCK 140). The heated dry process gas is supplied to the second supplemental adsorption unit 13 to heat the adsorbent therein (BLOCK 145). The supply of the heated dry process gas is maintained for a first time period, for example one (1) hour. The heater 28 is deactivated (BLOCK 150). The (unheated) dry process gas is supplied to the second supplemental adsorption unit 13 (BLOCK 155). The supply of the (unheated) dry process gas is maintained for a second time period, for example five (5) hours. The regeneration gas from the second supplemental adsorption unit 13 is cooled and returned to the inlet of the principal adsorption unit 11 (BLOCK 160). When the regeneration of the second supplemental adsorption unit 13 is complete, the apparatus 10 is reconfigured to perform regeneration of the first supplemental adsorption unit 12 (BLOCK 165). The process gas is supplied from the principal adsorption unit 11 to the second supplemental adsorption unit 13 (BLOCK 170). The second supplemental adsorption unit 13 is operative to dry the process gas while the first supplemental adsorption unit 12 is regenerated (BLOCK 175). The process continues alternating the first and second supplemental adsorption units 12, 13 between the different functions to maintain effective drying (and cleaning) of the process gases.

A schematic representation of the ECU is shown in FIG. 5. The ECU comprises at least one electronic processor 33 and a memory system 34. A set of computational instructions 35 is stored on the memory system 34. The electronic control unit ECU comprises one or more input 36A for receiving one or more input signal SIN-n, for example from one or more sensor (not shown); and one or more output 36B for outputting one or more output signal SOUT-n. When executed the computational instructions 35 cause the electronic control unit ECU to implement the method(s) described herein. The electronic control unit ECU controls the apparatus 10 to perform regeneration and/or drying of the process gases. In particular, the electronic control unit ECU is operable to configure the apparatus 10 such that either the first supplemental adsorption unit 12 or the second supplemental adsorption unit 13 is fluidly connected to the principal adsorption unit 11. The electronic control unit ECU may, for example, output control signals SOUT-n to control valves to re-configure the apparatus 10. The electronic control unit ECU is configured to output control signals S-n to control operation of the heater 28, the cooler 31 and the blower 32. The electronic control unit ECU may be connected to a human machine interface (HMI) 37 to receive user inputs. The electronic control unit ECU may be implemented in a proprietary system or in a general purpose computational device.

It will be appreciated that various modifications may be made to the embodiment(s) described herein without departing from the scope of the appended claims. The apparatus 10 cycles between the first and second supplemental adsorption units 12, 13 to dry of the process gases. Each adsorption unit alternates between drying (adsorption) and regeneration. It will be understood that the apparatus 10 may comprise more than two adsorption units, for example first, second and third adsorption units. The apparatus 10 may cycle between the first, second and third adsorption units.

The first and second supplemental adsorption units 12, 13 have been described as being provided in respective first and second vessels 18, 19. It will be understood that the first and second supplemental adsorption units 12, 13 could be disposed in the same vessel, for example in respective first and second chambers. Furthermore, the first and second supplemental adsorption units 12, 13 could be combined with the principal adsorption unit 11, for example in separate chambers.

BLOCK DIAGRAM LABELS

| | |
|---|---|
| 105 | SUPPLY PROCESS GAS |
| 110 | PROCESSING OF SUPPLY GAS |
| 115 | SUPPLY PROCESS GAS TO THE FIRST SUPPLEMENTAL |
| | ADSORPTION UNIT |
| 120 | FIRST SUPPLEMENTAL ADSORPTION UNIT PERFORMS |
| | SUPPLEMENTARY DRYING |
| 125 | DISCHARGE DRY PROCESS GAS FROM FIRST |
| | SUPPLEMENTAL ADSORPTION UNIT |
| 130 | DIVERT PORTION OF THE DRY PROCESS GAS |
| 135 | HEAT DRY PROCESS GAS FOR SUPPLY TO SECOND |
| | SUPPLEMENTAL ADSORPTION UNIT |
| 140 | SUPPLY HEATED DRY PROCESS GAS TO SECOND |
| | SUPPLEMENTAL ADSORPTION UNIT |
| 145 | REGENERATE SECOND SUPPLEMENTAL ADSORPTION |
| | UNIT |
| 150 | STOP HEATING DRY PROCESS GAS |
| 155 | SUPPLY (UNHEATED) DRY PROCESS GAS TO SECOND |
| | SUPPLEMENTAL ADSORPTION UNIT |
| 160 | RETURN REGENERATION GAS TO THE MAIN |
| | PROCESSING UNIT |
| 165 | RECONFIGURE APPARATUS FOR REGENERATION OF |
| | FIRST SUPPLEMENTAL ADSORPTION UNIT |
| 170 | SUPPLY PROCESS GAS TO THE SECOND |
| | SUPPLEMENTAL ADSORPTION UNIT |
| 175 | REPEAT PROCESS TO REGENERATE FIRST |
| | SUPPLEMENTAL ADSORPTION UNIT |

1. An apparatus for drying a process gas, the apparatus comprising:
a principal adsorption unit having an inlet for receiving a process gas from a compressor, and an outlet for discharging the process gas;
a first supplemental adsorption unit comprising an adsorbent for adsorbing water; and
a second supplemental adsorption unit comprising an adsorbent for adsorbing water;
wherein the apparatus is configured to fluidly connect the outlet of the principal adsorption unit to at least one of the first and second supplemental adsorption units, the at least one of the first and second supplemental adsorption units being operable to adsorb water to dry the process gas discharged from the principal adsorption unit.

2. The apparatus as claimed in claim 1, wherein the apparatus is configured to fluidly connect a selected one of the first and second supplemental adsorption units to the outlet of the principal adsorption unit, the selected one of the first and second supplemental adsorption units drying the process gas and discharging a dry process gas.

3. The apparatus as claimed in claim 2, wherein the apparatus is configured to supply a regeneration gas to the other one of the first and second supplemental adsorption units to regenerate the adsorbent disposed therein.

4. The apparatus as claimed in claim 3, wherein the regeneration gas comprises at least a portion of the dry process gas discharged from the selected one of the first and second supplemental adsorption units.

5. (canceled)

6. The apparatus as claimed in claim 3, comprising a heater for heating the regeneration gas;
wherein, during a regeneration process, the heater is activated for a first time period to heat the regeneration gas and is then deactivated for a second time period, the regeneration gas being supplied throughout the regeneration process.

7.-8. (canceled)

9. The apparatus as claimed in claim 3, wherein the apparatus is configured to introduce the regeneration gas into the principal adsorption unit after being supplied to the other one of the first and second supplemental adsorption units to regenerate the adsorbent disposed therein.

10. The apparatus as claimed in claim 9, further comprising a cooler for cooling the regeneration gas prior to introduction into the principal adsorption unit.

11. The apparatus as claimed in claim 9, further comprising a compressor for compressing the regeneration gas prior to introduction into the principal adsorption unit.

12. The apparatus as claimed in claim 2, wherein the apparatus is configured to change the selection one of the first and second supplemental adsorption units such that the other one of the first and second supplemental adsorption units is operative to dry the process gas and discharging a dry process gas.

13. A method of drying a process gas, the method comprising:
discharging the process gas from a principal adsorption unit;
selectively supplying the process gas from the principal adsorption unit to at least one of a first supplemental adsorption unit and a second supplemental adsorption unit, the at least one of the first and second supplemental adsorption units adsorbing water to dry the process gas.

14. The method as claimed in claim 13, wherein the method further comprises fluidly connecting a selected one of the first and second supplemental adsorption units to the principal adsorption unit, the selected one of the first and second supplemental adsorption units drying the process gas and discharging a dry process gas.

15. The method as claimed in claim 14, wherein the method further comprises supplying a regeneration gas to the other one of the first and second supplemental adsorption units to regenerate an adsorbent disposed therein.

16. The method as claimed in claim 15, wherein the regeneration gas comprises at least a portion of the dry process gas discharged from the selected one of the first and second supplemental adsorption units.

17. The method as claimed in claim 15, further comprising heating the regeneration gas; and
during a regeneration process, supplying the heated regeneration gas for a first time period and supplying the unheated regeneration gas for a second time period.

18. (canceled)

19. The method as claimed in claim 18, wherein the second time period is longer than the first time period.

20. The method as claimed in claim 15, wherein the method further comprises introducing the regeneration gas into the principal adsorption unit after being supplied to the other one of the first and second supplemental adsorption units to regenerate the adsorbent disposed therein.

21. The method as claimed in claim 20, further comprising cooling the regeneration gas prior to introduction into the principal adsorption unit.

22. The method as claimed in claim 20, further comprising compressing the regeneration gas prior to introduction into the principal adsorption unit.

23. The method as claimed in claim 14, wherein the method further comprises changing the selected one of the first and second supplemental adsorption units such that the other one of the first and second supplemental adsorption units is operative to dry the process gas and discharge a dry process gas.

24. A non-transitory computer-readable medium having a set of instructions stored therein which, when executed, cause a processor to perform the method claimed in claim 13.
